(19) United States
(12) Patent Application Publication
(10) Pub. No.: US 2017/0168654 A1
(43) Pub. Date: Jun. 15, 2017

(54) ORGANIZE COMMUNICATIONS ON TIMELINE

(71) Applicant: MICROSOFT TECHNOLOGY LICENSING, LLC, Redmond, WA (US)

(72) Inventors: Ned Bearer Friend, Seattle, WA (US); Vignesh Sachidanandam, Seattle, WA (US); Avneesh Kohli, Bellevue, WA (US); Ashwini Purohit, Seattle, WA (US); March Rogers, Bellevue, WA (US); Hiroshi Tsukahara, Bellevue, WA (US)

(21) Appl. No.: 14/965,930

(22) Filed: Dec. 11, 2015

(51) Int. Cl. G06F 3/0481; G06F 3/0485; G06F 3/0484

(52) U.S. Cl. CPC G06F 3/0481; G06F 3/04847; G06F 3/0485

(57) ABSTRACT

Organization of communications on a timeline is provided. A communication application initiates operations to organize the communication on the timeline by analyzing communications to identify a group of the communications associated with a current date. The group of the communications share common attributes such as a topic, a subject, a participant or a stakeholder. A today visualization is created from the group of the communications. Furthermore, the today visualization is presented before other communications on the timeline.

### BACKGROUND

People interact with computer applications through user interfaces. While audio, tactile, and similar forms of user interfaces are available, visual user interfaces through a display device are the most common form of a user interface. With the development of faster and smaller electronics for computing devices, smaller size devices such as handheld computers, smart phones, tablet devices, and comparable devices have become common. Such devices execute a wide variety of applications ranging from communication applications to complicated analysis tools. Many such applications facilitate communication management.

Vast number of received communications complicate discovery and management of incoming communications. Indeed, updates, changes, and/or additions to communications cause difficulties in upkeep of communications maintained by an individual. While maintaining communications, an additional layer of complication faced by an individual includes multiple accounts of the individual. Complications with multiple accounts and vast number of communications may lead to mismanagement of communications.

### SUMMARY

This summary is provided to introduce a selection of concepts in a simplified form that are further described below in the Detailed Description. This summary is not intended to, exclusively identify key features or essential features of the claimed subject matter, nor is it intended as an aid in determining the scope of the claimed subject matter.

Embodiments are directed to organization of communications on a timeline, in some examples, a communication application may analyze communications to identify a group of the communications associated with a current date. A today visualization may be created from the group of communications. Next, the today visualization may be presented before the communications on the timeline.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example of organizing communications on a timeline, according to embodiments;

FIG. 2A and FIG. 2B are display diagrams illustrating an example of organizing a group of communications associated with a current date, according to embodiments;

FIG. 3A and FIG. 3B are display diagrams illustrating an example of organizing a group of communications associated with a future date, according to embodiments;

FIG. 4A and FIG. 4B are display diagrams illustrating an example of organizing a communication based on a snooze action, according to embodiments;

FIG. 5 is a display diagram illustrating an example of highlighting a next appointment on a timeline, according to embodiments;

FIG. 6 is a simplified networked environment, where a system according to embodiments may be implemented;

FIG. 7 is a block diagram of an example computing device, which may be used to organize communications on a timeline, according to embodiments; and

FIG. 8 is a logic flow diagram illustrating a process for organizing communications on a timeline, according to embodiments.

### DETAILED DESCRIPTION

As briefly described above, a communication application organizes communications on a timeline. The communication application may include an email processing application, a document processing application a messaging application, and/or a conferencing application, among others. In an example scenario, the communication application may analyze communications to identify a group of the communications associated with a current date. The current date includes a 24 hour time period. The communications may include an email, a message, a calendar item, a task, and/or a note, among others.

A today visualization may be created from the group of the communications. The today visualization may include a label such as “today” that identifies an urgency of the group of the communications in relation to the current date. Next, the today visualization may be presented before the communications on the timeline. The group of the communications may be presented adjacent to the today visualization within a today region before a remaining set of the communications.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a physical computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components to organize communications on a timeline. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. A file is any form of structured data that is associated with audio, video, or similar content. An operating system is a system configured to manage hardware and software components of a computing device that provides common services and applications. An integrated module is a component of an application or service that is integrated within the application or service such that the application or service is configured to execute the component. A computer-readable memory device is a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience a visual display associated with an application or service through which a riser interacts with the application or service. A user action refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

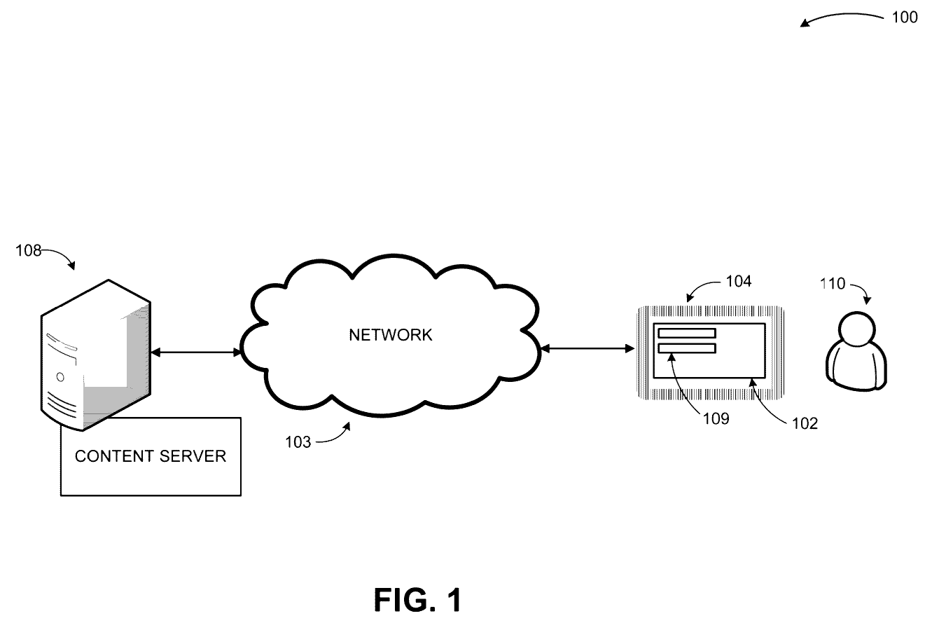

FIG. 1 is a conceptual diagram illustrating an example of organizing communications on a timeline, according to embodiments.

In a diagram 100, a computing device 104 may execute a communication application 102. Examples of the communication application 102 may include an email processing application, a document processing application, a messaging application, and/or a conferencing application, among others. The computing device 104 may include a tablet device, a laptop computer, a desktop computer, and a smart phone, among others. The computing device 104 may include a special purpose computing device configured to provide communications management through a display component configured to display communications and/or documents, a communication component configured to transmit communications and/or documents, and/or a storage component configured to store communications and/or documents, among other components.

The computing device 104 may display the communication application 102 to a participant 110. The participant 110 may interact with other participants through a communication 109. The participant 110 may be allowed to interact with the communication application 102 through an input device or touch enabled display component of the computing device 104. The computing device 104 may also include a display device such as the touch enabled display component, and a monitor, among others to provide the communication application 102 to the participant 110.

The communication application 102 may analyze communications to identify a group of the communications associated with a current date. The communications may include an email, a message, a calendar item, a task, and/or a note, among others. A today visualization may be created from the group of the communications. The today visualization may include a label such as a shared topic, a shared subject, and/or a summary, among other labels that identify an urgency of the group of the communications in relation to the current date. Next, the today visualization may be presented before the communications on the timeline. The group of the communications may be presented next to the today visualization within a today region before of a remaining set of the communications on the timeline.

The communication 109 may be stored and managed locally within the computing device 104. Alternatively, the communication 109 may be retrieved from a server 108. The server 108 may include a content server and/or a communication server, among others. The server 108 may also host and manage communications. An example of the server 108 may include an email server that provides communications to be presented by the communication application 102. Additionally, the computing device 104 may communicate with the server 108 through a network 103. The network 103 may provide wired or wireless communications between nodes such as the computing device 104, or the server 108, among others.

Alternatively, the server 108 may provide the communication application 102. The computing device 104 may provide a client interface of the communication application 102. The server 108 may execute operations to organize the communication 109 on a timeline through the communication application 102.

The participant 110 may interact with the communication application 102 with a keyboard based input, a mouse based input, a voice based input, a pen based input, and a gesture based input, among others. The gesture based input may include one or more touch based actions such as a touch action, a swipe action, and a combination of each, among others.

While the example system in FIG. 1 has been described with specific components including the computing device 104, the communication application 102, embodiments are not limited to these components or system configurations and can be implemented with other system configuration employing fewer or additional components.

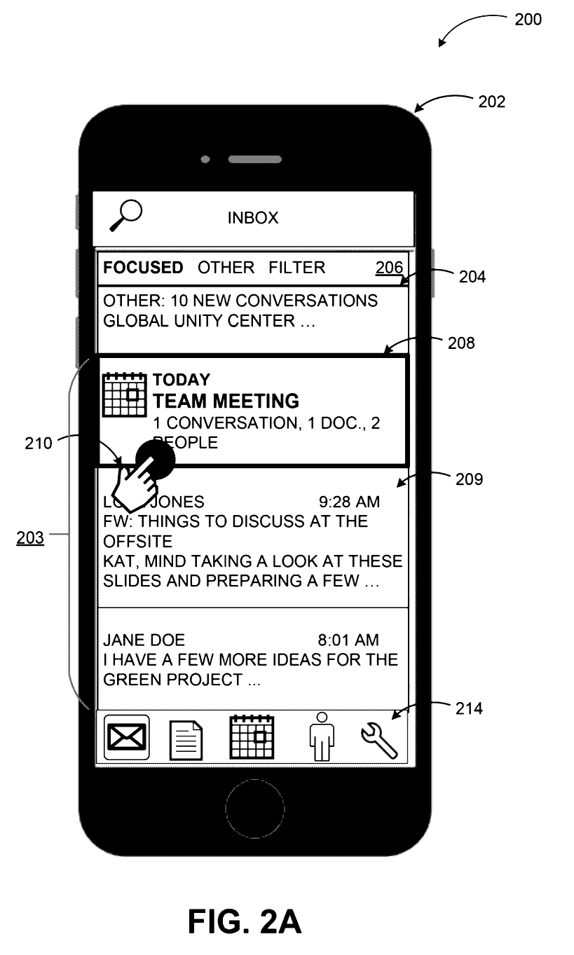

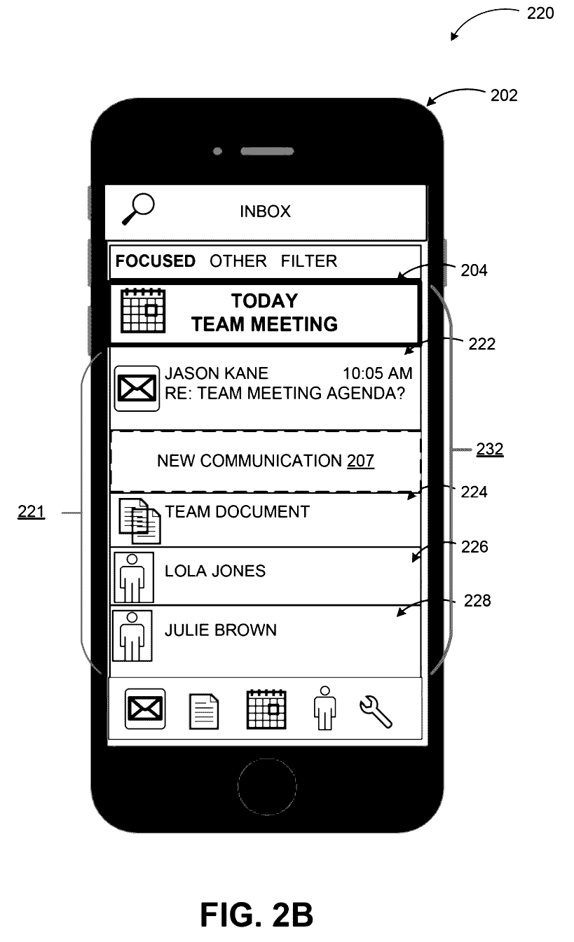

FIG. 2A and FIG. 2B are display diagrams illustrating an example of organizing a group of communications associated with a current date, according to embodiments.

In a diagram 200, a communication application 202 may analyze communications to identify a group of the communications associated with a current date. The communications may include an email, a message, a calendar item, a task, and/or a note, for example. The current date may also be referred to as today. A content module of the communication application 202 may parse content of communications in an inbox to identify a relationship with the current date. For example, a task with a due date of the current date may be inserted into the group of the communications. An email with a content describing a topic associated with the current date may also be inserted into the group of the communications.

The group of communications associated with the current date may also be created based on a shared attribute between the communications. The shared attribute may include a subject, a topic, keyword(s), stakeholder(s), participant(s), a date and time, and/or a duration, among other attributes shared by the communications.

A today visualization 208 may be generated from the group of the communications. The today visualization 208 may include a label to distinguish an urgency associated with the group of the communications in relation to the current date. The urgency associated with the current may differentiate the group of the communications with other communications not associated with the current date. The today visualization may also include a listing of type(s) of the communications and a number of each type of the communications within the group.

A rendering module of the communication application 202 may display the today visualization 20 before other communications 209 on a timeline 203. The timeline 203 may include a listing of the communications sorted based on a time associated with the communications such as a receiving date/time and/or a transmission date/time, among others. The rendering module may also display filtering elements 206 to sort and organize the communications and a summary listing 204 that provides a summary information associated with the communications. The rendering module may also present link elements 214 to access other functionality provided by the communication application 202.

The rendering module of the communication application 202 may detect a request 210 to expand the today visualization 208. In a diagram 220, in response to the request 210, the rendering module of the communication application 202 may display the group 221 of the communications (222, 224, 226, and 228) associated with the current date. The group 221 may include an email, a document, and contacts. The group 221 of the communications may be displayed along with the today visualization 204 within a today region 232 before other communications on the timeline.

The content module may also receive a new communication 207. The new communication 207 may be analyzed to identify an association with the current date. In response to finding the association with the current date, the new communication 207 may be inserted into the group of the communications. The rendering module may update the group 221 of communications (222, 224, 226, and 228) to display the new communication 207 within the today region 232. Alternatively, in response to finding no association with the current date, the new communication 207 may be displayed after the today visualization 204 and the group 221 of the communications within the today region 232.

Furthermore, the content module may detect a date change event. In response to the date change event, the current date may be changed to a new date. The rendering module may remove the today visualization 204 from the timeline. The group 221 of communications (222, 224, 226, and 228) may be ungrouped. A new communication 207 may be displayed before the group 221 of the communications (222, 224, 226, and 228).

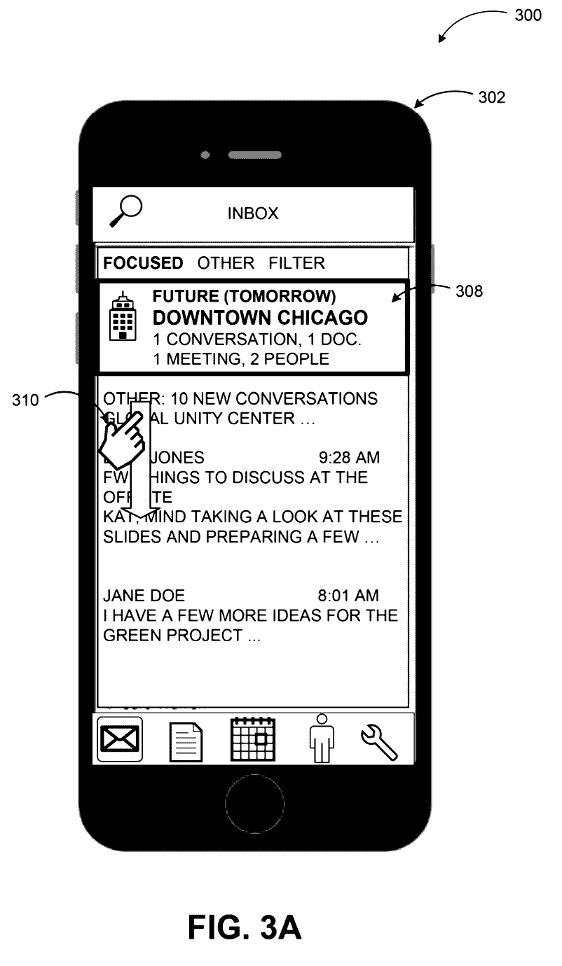

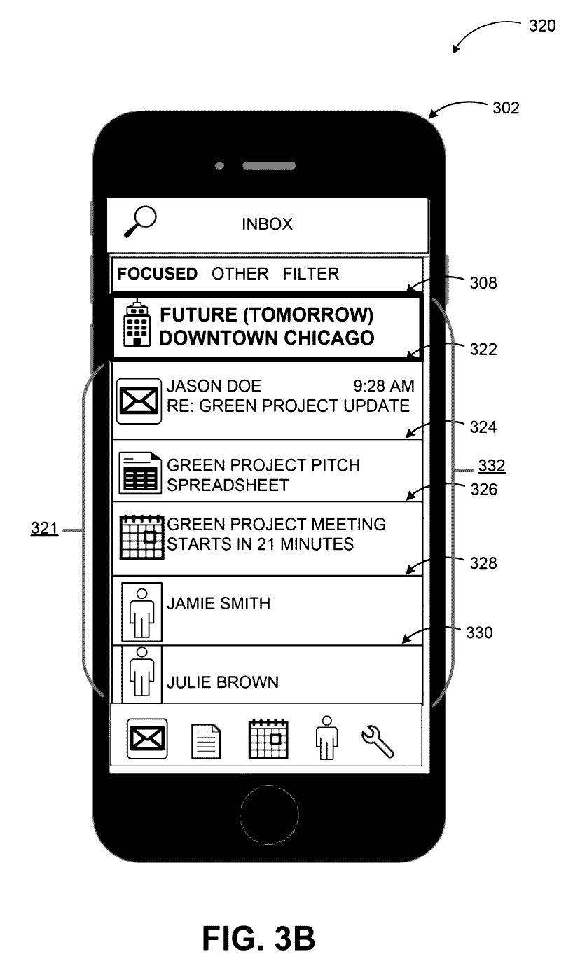

FIG. 3A and FIG. 3B are display diagrams illustrating an example of organizing a group of communications associated with a future date, according to embodiments.

In a diagram 300, a communication application 302 may present a future visualization 308. A content module of the communication application 302 may analyze the communications to identify a group 321 of the communications associated with a future date. For example, a task due on a future date may be inserted to the group 321 of the communications. An email discussing a project due date on the future date may be inserted to the group 321 of the communications. The group 321 may also be created based on communications with shared attributes such as a topic and/or a subject, among others. The content module may create the future visualization 308 based on the group 321 of the communications.

A rendering module of the communication application 302 may position the future visualization 308 in a hidden region before the other communications and a today visualization on the timeline. The rendering module may display the future visualization 308 in response to a request 310. The request 310 may include a scroll down action on the timeline. In response to the request 310, the future visualization may be displayed before the other communications and before the today visualization. The future visualization 30 may provide a summary of the group 321 of the communications such as a shared topic or a shared subject. The future visualization 308 may also display types of the communications within the group 321 and a number of the communications within the types.

In a diagram 320, the rendering module of the communication application 302 may display the future visualization 308 and the group 321 of the communications (322, 324, 326, 328, and 330) within a future region 332 on the timeline, in response to a request to expand the future visualization 308. The group 321 of the communications (322, 324, 326, 328, and 330) may include an email, a document, a calendar event, and/or contact(s), among others. The future region 332 may be displayed before the other communications on the timeline or a today region on the timeline. The today region may include a today visualization and a group of the communications associated with a current date.

In an example scenario, the content module may detect a date change event. The date change event may include the current date equaling the future date. In response to the date change event, a today visualization displayed by the rendering module may be overwritten with a content of the future visualization 308. The rendering module may present the group of the communication associated with the future date (that has become the current date) within the today region along with the today visualization. The future visualization 308 may be removed.

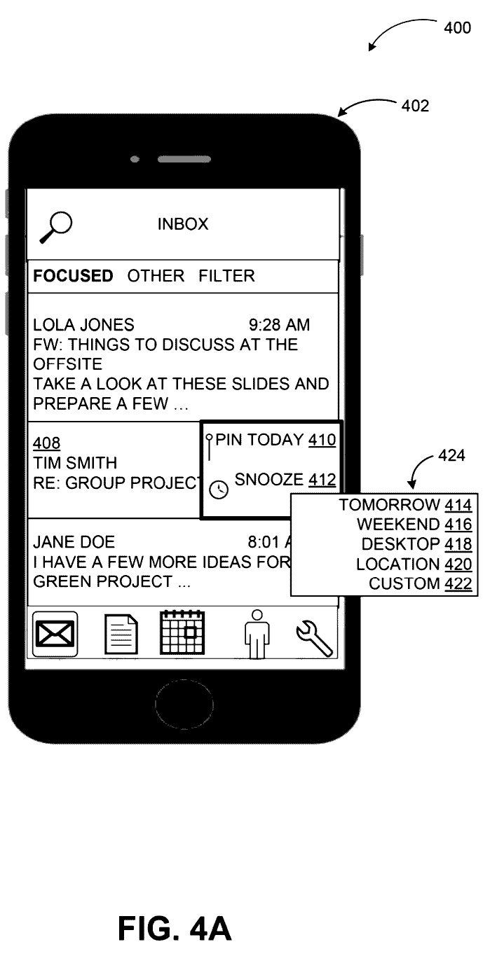

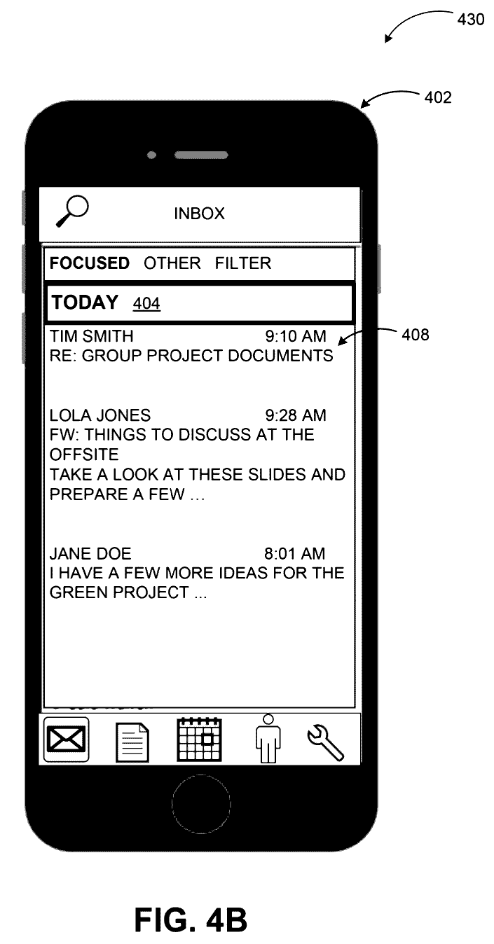

FIG. 4A and FIG. 4B are display diagrams illustrating an example of organizing a communication based on a snooze action, according to embodiments.

In a diagram 400, a communication application 402 may provide a pin element 410 and a snooze element 412 to organize a selected communication 408. The pin element 410 may provide operations to relate the selected communication 408 with a today visualization and a group of the communications associated with a current date. Alternatively, another pin element may also be provided with operations to relate the selected communication 408 with a future visualization and a group of the communications associated with a future date.

A link list 424 may be displayed in response to a detected action on the snooze element 412. The link list 424 may include a tomorrow element 414 with operations to insert the selected communication 408 into a group of the communications associated with a future date. The link list 424 may also include a weekend element 416 with operations to insert the selected communication 408 into a group of the communications associated with a date range on an upcoming weekend. The link list 424 may also include a desktop element 418 with operations to insert the selected communication 408 into a group of the communications associated with a location on a desktop. The link list 424 may also include a location element 420 with operations to insert the selected communication 408 into a group of the communications associated with a location. The link list 424 may also include a custom element 422 with operations to insert the selected communication 408 into a group of the communications associated with a custom location or date.

The communication application 402 may detect a request to snooze the selected communication 408 within a time block. In response to the request, a calendar event associated with the selected communication 408 may be generated on the time block within a calendar. Next, the communication application 402 may prevent a creation of a new calendar event on the time block.

In a diagram 430, a date of the time block may be identified as a current date. The selected communication may be inserted into a group of communications associated with a current date. Next, the selected communication 408 and the today visualization 404 may be displayed in a today region before other communications on the timeline. Furthermore, when the current time is detected as within the time block associated with the selected communication 408, a reminder associated with the selected communication 408 may be displayed at a top position on the timeline.

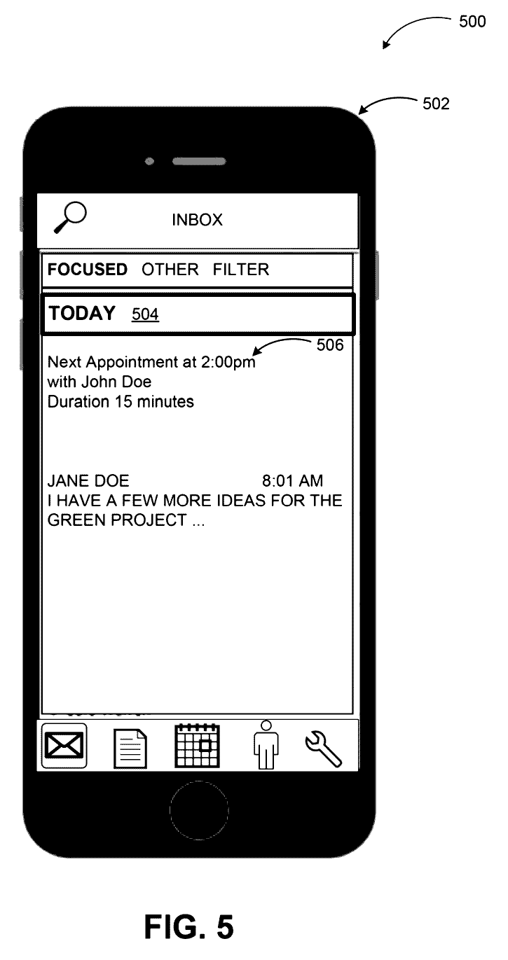

FIG. 5 is a display diagram illustrating an example of highlighting a next appointment on a timeline, according to embodiments.

In a diagram 500, a communication application 502 may display a reminder associated with an appointment. The communication application 502 may analyze the communications to identify an appointment within a group of the communications associated with a current date. A today visualization 504 may be updated to display a summary of the appointment 506 such as a time, a participant, and a duration of the appointment 506. Alternatively, a summary of the appointment 506 may displayed in a today region along, with the today visualization before other communications on the timeline.

As discussed above, the application be employed to perform operations is automate organization of communications on a timeline. An increased user efficiency with the communication application 102 may occur as a result of organizing the communications on a timeline. Additionally, presentation a group of communications associated with a current date or a future date with a corresponding visualization by the communication application 102 may reduce processor load, increase processing speed, conserve memory, and reduce network bandwidth usage.

Embodiments, as described herein, address a need that arises from a lack of efficiency between the participant 110 interacting with the communication application 102 of the computing device 104. The actions/operations described herein are not a mere use of a computer, but address results that are a direct consequence of software used as a service offered to large numbers of users and applications.

The example scenarios and schemas in FIG. 1 through 5 are shown with specific components, data types, and configurations. Embodiments are not limited to systems according to these example configurations. Organizing communications on a timeline may be implemented in configurations employing fewer or additional components in applications and user interfaces. Furthermore, the example schema and components shown in FIG. 1 through 5 and their subcomponents may be implemented in a similar manner with other values using the principles described herein.

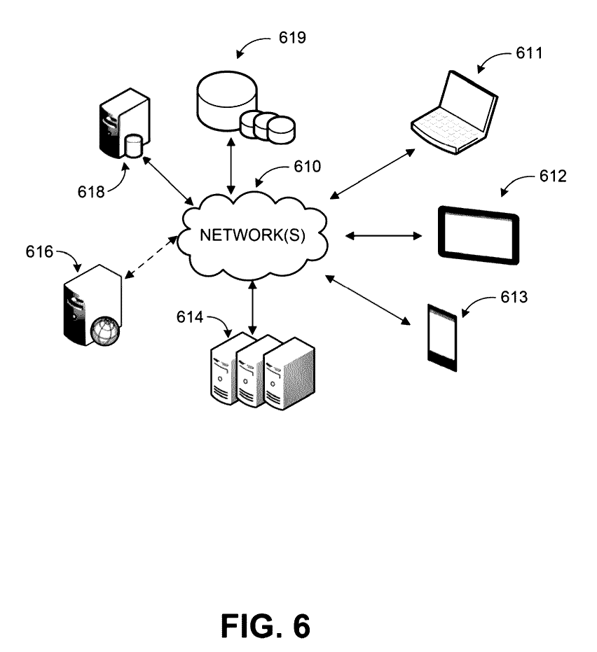

FIG. 6 is an example networked environment, where embodiments may be implemented. A communication application configured to organize communications on a timeline may be implemented via software executed over one or more servers 614 such as a hosted service. The platform may communicate with client applications on individual computing devices such as a smart phone 613, a mobile computer 612, or desktop computer 611 (‘client devices’) through network(s) 610.

Client applications executed on any of the client devices 611-613 may facilitate communications via application(s) executed by servers 614, or on individual server 616. A communication application may analyze communications to identify a group of the communications associated with a current date. A today visualization may be created from the group of the communications. Next, the today visualization may be displayed before the communications on a timeline. The communication application may store data associated with a communication in data store(s) 619 directly or through database server 618.

Network(s) 610 may comprise any topology of servers, clients, Internet service providers, and communication media. A system according to embodiments may have a static or dynamic topology. Network(s) 610 may include secure networks such as an enterprise network, an unsecure network such as a wireless open network, or the Internet. Network(s) 610 may also coordinate communication over other networks such as Public Switched Telephone Network (PSTN) or cellular networks. Furthermore, network(s) 610 may include short range wireless networks such as Bluetooth or similar ones. Network(s) 610 provide communication between the nodes described herein. By way of example, and not limitation, network(s) 610 may include wireless media such as acoustic, RF, infrared and other wireless media.

Many other configurations of computing devices, applications, data sources, and data distribution systems may be employed to organize communications on a timeline. Furthermore, the networked environments discussed in FIG. 6 are for illustration purposes only. Embodiments are not limited to the example applications, modules, or processes.

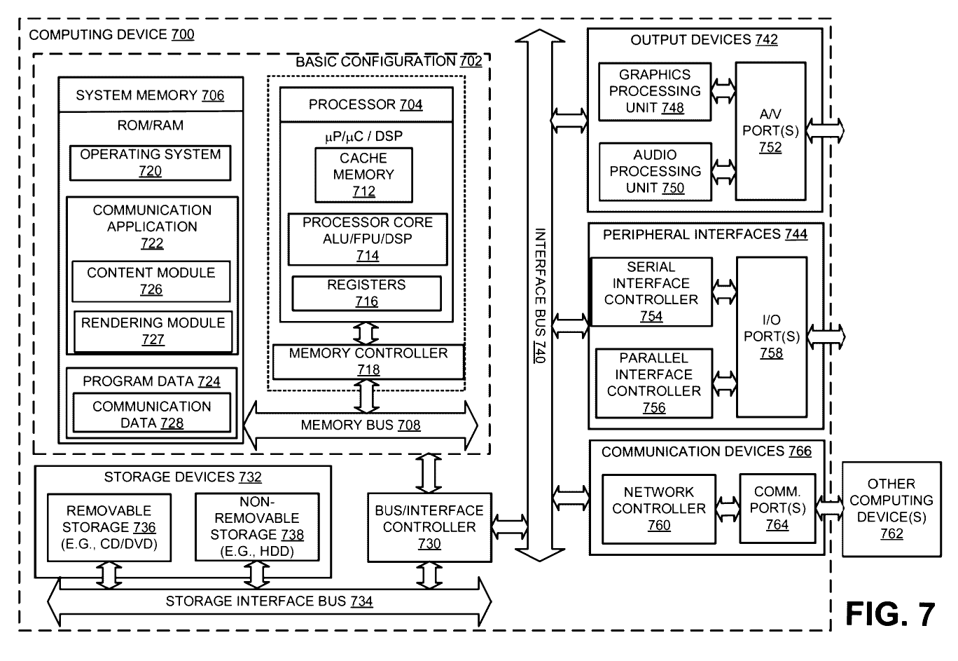

FIG. 7 is a block diagram of an example computing device, which may be used to organize communications on a timeline, according to embodiments.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communication between the processor 704 and the system memory 706. The basic configuration 702 may be illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof. The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations, the memory controller 718 may be an internal part of the processor 704.

Depending on the desired configuration, the system memory 706 may be of any type including but not limited to volatile memory (such as RAM), non-volatile memory (such as ROM, flash memory, etc.), or any combination thereof. The system memory 706 may include an operating system 720, a communication application 722, and a program data 724. The communication application 722 may include components such as a content module 726 and a rendering module 727. The content module 726 and the rendering module 727 may execute the processes associated with the communication application 722. The content module 726 may analyze communications to identify a group of the communications associated with a current date. A today visualization is created from the group of the communications. Next, the rendering module 727 displays the today visualization before the communications on the timeline.

Components of the communication application 722 (such as a user interface) may also be displayed on a display device associated with the computing device 700. An example of the display device may include a hardware screen that may be communicatively coupled to die computing device 700. The display device may include a touch based device that detects gestures such as a touch action. The display device may also provide feedback in response to detected gestures (or any other form of input) by transforming a user interface of the communication application 722, displayed by the touch based device. The program data 724 may also include, among other data, communication data 728, or the like, as described herein. The communication data 728 may include a date and time, a subject, and/or a topic, among others.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more, non-removable storage devices 738, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 766) to the basic configuration 702 via the bus/interface controller 730. Some of the example output devices 742 include a graphics processing unit 748 and an audio processing unit 750, which may be configured to communicate to various external devices such as a display or speakers via one or more A/V ports 754. One or more example peripheral interfaces 744 may include a serial interface controller 754 or a parallel interface controller 756, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 766 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information deliver media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer, which includes any of the above functions. The computing device 700 may also be implemented as a personal computer including both laptop computer and non-laptop computer configurations.

Example embodiments may also include methods to organize communications on a timeline. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

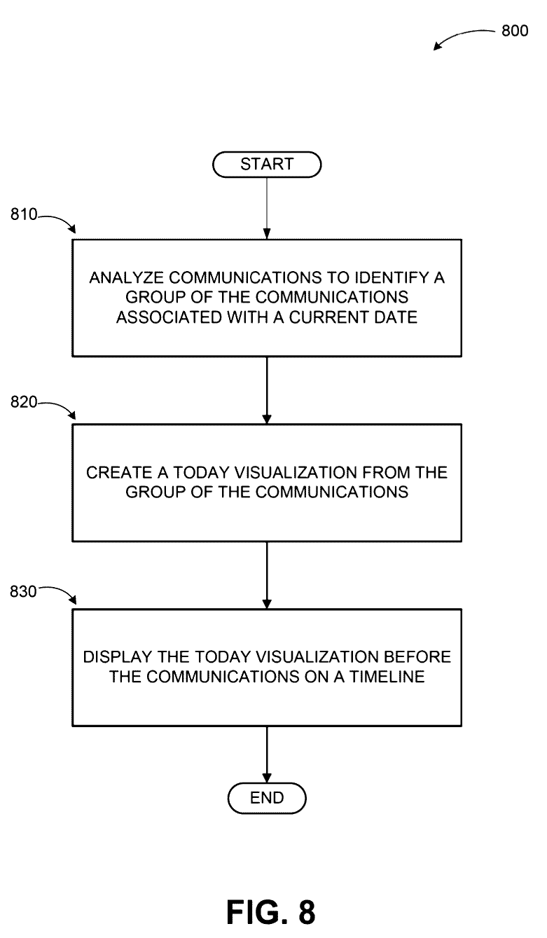

FIG. 8 is a logic flow diagram illustrating a process for organizing communications on a timeline, according to embodiments. Process 800 may be implemented on a computing device, such as the computing device 700 or another system.

Process 800 begins with operation 810, where a communication application may analyze communications to identify a group of the communications associated with a current date. A content of the communications may be parsed to identify a shared attribute such as a topic or a subject and an association with the current date. At operation 820, a today visualization is created from the group of the communications. The today visualization may present the shared attribute and/or a type of the communications within the group and a number the communications within a type. At operation 830, the today visualization is presented before the communications on the timeline. The today visualization may be presented along with the group of the communications within a today region positioned before the other communications.

The operations included in process 800 are for illustration purposes. Organizing communication on a timeline may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

In some examples, a computing device for organizing communications on a timeline is described. The computing device includes a display device, a memory configured to store instructions associated with a communication application, and one or more processors coupled to the memory and the display device. The one or more processors execute the communication application in conjunction with the instructions stored in the memory. The communication application includes a content module and a rendering module. The content module is configured to analyze communications to identify a group of the communications associated with a current date and create a today visualization from the group of the communications. The rendering module is configured to present, on the display device, the today visualization distinguished from remaining communications on the timeline.

In other examples, the communications include one or more of an email, a message, a calendar item, a task, and a note. The rendering module is further configured to detect a request to expand the today visualization and display, on the display device, the group of the communications within a today region on the timeline, wherein the today region includes the today visualization and the group of the communications. The content module is further configured to receive a new communication, analyze the new communication to identify an association with the current date, insert the new communication into the group of the communications, and provide an update to the rendering module to present the new communication along with the group of the communications.

In further examples, the content module is further configured to receive a new communication, analyze the new communication to detect no association with the current date, and instruct the rendering module to display the new communication outside the today visualization and the group of the communications on the timeline. The content module is further configured to identify a subset of the communications associated with the current date with one or more shared attributes, wherein the one or more shared attributes include one or more of a subject, a topic, one or more keywords, one or more stakeholders, a date and time, and a duration and create the group of the communications from the subset of the communications. The content module is further configured to detect a date change event, wherein the current date is assigned a new date and instruct the rendering module to release the today visualization and the group of the communications. The rendering module is further configured to remove the today visualization from the timeline and ungroup the group of the communications.

In other examples, the content module is further configured to analyze the communications to identify another group of the communications associated with a future date, create a future visualization from the other group of the communications and provide the future visualization to the rendering module for positioning in a hidden region before the today visualization on the timeline. The rendering module is further configured to detect a request to display the future visualization, wherein the request includes a scroll action on the timeline and display, on the display device, the future visualization distinguished from the today visualization and the communications on the timeline, detect another request to expand the future visualization, and display, on the display device, the other group of the communications within a future region on the timeline, wherein the future region includes the future visualization and the other group of the communications, and wherein the future region is placed before the today visualization and the communications on the timeline. The content module is further configured to detect a date change event, wherein the current date is set to the future date, overwrite the today visualization with a content of the future visualization, remove the future visualization, and instruct the rendering module to present the other group of the communications along with the today visualization within a today region of the timeline.

In some examples, a method executed on a computing device for organizing communications on a timeline is described. The method includes analyzing communications to identify a group of the communications associated with a current date, wherein the communications include one or more of an email, a message, a calendar item, a task, and a note, creating a today visualization from the group of the communications, and presenting the today visualization distinguished from remaining communications on the timeline.

In other examples, the method further includes detecting a request to snooze a selected communication from the communications within a time block, generating a calendar event for the selected communication on the time block within a calendar, and preventing a creation of a new calendar event on the time block. The method further includes identifying a date of the time block as the current date, inserting the selected communication into the group of the communications, and displaying the group of the communications and the today visualization in a today region before the communications on the timeline. The method further includes detecting a current time as within the time block and displaying a reminder associated with the selected communication in a top position on the timeline. The method further includes identifying a next appointment within the group of the communications and updating the today visualization to display the next appointment.

In some examples, a computer-readable memory device with instructions stored thereon for organizing communications on a timeline is described. The instructions includes actions that are similar to the actions of the method.

In some examples, a means for organizing communications on a timeline is described. The means for organizing communications on a timeline includes a means for analyzing communications to identify a group of the communications associated with a current date, a means for creating a today visualization from the group of the communications, and a means for presenting the today visualization distinguished from remaining communications on the timeline.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device for organizing communications on a timeline, the computing device comprising:
a display device;
a memory configured to store instructions associated with a communication application;
one or more processors coupled to the memory and the display device, the one or more processors executing the communication application in conjunction with the instructions stored in the memory, wherein the communication application includes:
a content module configured to:
analyze communications to identify a group of the communications associated with a current date;
create a today visualization from the group of the communications; and
a rendering module configured to:
present, on the display device, the today visualization distinguished from remaining communications on the timeline.

2. The computing device of claim 1, wherein the communications include one or more of an email, a message, a calendar item, a task, and a note.

3. The computing device of claim 1, wherein the rendering module is further configured to:
detect a request to expand the today visualization; and
display, on the display device, the group of the communications within a today region on the timeline, wherein the today region includes the today visualization and the group of the communications.

4. The computing device of claim 1, wherein content module is further configured to:
receive a new communication;
analyze the new communication to identify an association with the current date;
insert the new communication into the group of the communications; and
provide an update to the rendering module to present the new communication along with the group of the communications.

5. The computing device of claim 1, wherein the content module is further configured to:
receive a new communication;
analyze the new communication to detect no association with the current date; and
instruct the rendering module to display the new communication outside the today visualization and the group of the communications on the timeline.

6. The computing device of claim 1, wherein the content module is further configured to:
identify a subset of the communications associated with the current date with one or more shared attributes, wherein the one or more shared attributes include one or more of a subject, a topic, one or more keywords, one or more stakeholders, a date and time, and a duration; and
create the group of the communications from the subset of the communications.

7. The computing device of claim 1, wherein the content module is further configured to:
detect a date change event, wherein the current date is assigned a new date; and
instruct the rendering module to release the today visualization and the group of the communications.

8. The computing device of claim 7, wherein the rendering module is further configured to:
remove the today visualization from the timeline; and
ungroup the group of the communications.

9. The computing device of claim 1, wherein the content module is further configured to:
analyze the communications to identify another group of the communications associated with a future date;
create a future visualization from the other group of the communications; and
provide the future visualization to the rendering module for positioning in a hidden region before the today visualization on the timeline.

10. The computing device of claim 9, wherein the rendering module is further configured to:
detect a request to display the future visualization, wherein the request includes a scroll action on the dateline; and
display, on the display device, the future visualization distinguished from the today visualization and the communications on the timeline.

11. The computing device of claim 10, wherein the rendering module is further configured to:
detect another request to expand the future visualization; and
display, on the display device, the other group of the communications within a future region on the timeline, wherein the future region includes the future visualization and the other group of the communications, and wherein the future region is placed before the today visualization and the communications on the timeline.

12. The computing device of claim 9, wherein the content module is further configured to:
detect a date change event, wherein the current date is set to the future date;
overwrite the today visualization with a content of the future visualization;
remove the future visualization; and
instruct the rendering module to present the other group of the communications along with the today visualization within a today region of the timeline.

13. A method executed on a computing device for organizing communications on a timeline, the method comprising:
analyzing communications to identify a group of the communications associated with a current date, wherein the communications include one or more of an email, a message, a calendar item, a task, and a note;
creating a today visualization from the group of the communications; and
presenting the today visualization distinguished from remaining communications on the timeline.

14. The method of claim 13, further comprising:
detecting a request to snooze a selected communication from the communications within a time block;
generating a calendar event for the selected communication on the time block within a calendar; and
preventing a creation of a new calendar event on the time block.

15. The method of claim 14, further comprising:
identifying a date of the time block as the current date;
inserting the selected communication into the group of the communications; and
displaying the group of the communications and the today visualization in a today region before the communications on the timeline.

16. The method of claim 14, further comprising:
detecting a current time as within the time block; and
displaying a reminder associated with the selected communication in a top position on the timeline.

17. The method of claim 13, further comprising:
identifying a next appointment within the group of the communications; and
updating the today visualization to display the next appointment.

18. A computer-readable memory device with instructions stored thereon for organizing communications on a timeline, the instructions comprising:
analyzing communications to identify a group of the communications associated with a current date, wherein the communications include one or more of an email, a message, a calendar item, a task, and a note;
creating a today visualization from the group of the communications;
presenting the today visualization before the communications on the timeline;
detecting a request to expand the today visualization; and
displaying, on the display device, the group of the communications within a today region on the timeline, wherein the today region includes the today visualization and the group of the communications.

19. The computer-readable memory device of claim 18, wherein the instructions further comprise:
analyzing the communications to identify other group of the communications associated with a future date;
creating a future visualization from the other group of the communications; and
displaying the future visualization before the today visualization and the communications on the timeline.

20. The computer-readable memory device of claim 18, wherein the instructions further comprise:
detecting a request to snooze a selected communication from the communications within a time block;
generating a calendar event for the selected communication on the time block within a calendar;
preventing a creation of a new calendar event on the time block;
identifying a date of the time block as the current date;
inserting the selected communication into the group of the communications; and
displaying the group of the communication and the today visualization in a today region before the communications on the timeline.
